(19) United States
(12) Patent Application Publication
(10) Pub. No.: US 2021/0204063 A1
(43) Pub. Date: Jul. 1, 2021

(54) DRUM PAPER AND LOUDSPEAKER HAVING IMPROVED SURROUND ELEMENT AND REDUCED SOUND DISTORTION

(71) Applicant: Vanson Electronics (Nanhai) Co., Ltd., Foshan City (CN)

(72) Inventors: Ching-Shan Hsu, Taipei City (TW); Hao-Chien Hsu, Taipei City (TW)

(21) Appl. No.: 16/826,309

(22) Filed: Mar. 23, 2020

(30) Foreign Application Priority Data
Dec. 27, 2019 (CN) 201922400541.4

(51) Int. Cl. H04R 7/18; H04R 1/28

(52) U.S. Cl. CPC H04R 7/18; H04R 9/06; H04R 2307/207; H04R 1/288

(57) ABSTRACT

The present disclosure provides a surround element, distortion-reducing drum paper, and a loudspeaker, and relates to the technical field of loudspeakers. The surround element is provided with an anti-distortion structure, and the anti-distortion structure includes at least one convex arc and at least one concave arc. The convex arc and the concave arc are connected to each other in a radial direction. The convex arc and the concave arc have different arc radii. The disclosure greatly reduces the stiffness K of the drum paper with the change of the position of the voice coil, thereby achieving the effect of reducing sound distortion.

### BACKGROUND OF THE INVENTION

### 1. Field of the Invention

The present disclosure relates to the technical field of loudspeakers, and in particular relates to a drum paper and a loudspeaker having an improved surround element and reduced sound distortion.

### 2. Description of the Prior Art

Sound distortion of loudspeakers has been a difficult problem for a long time.

For systems with input and output, the ideal situation is that the transfer function is linear and does not change with time. The magnitude and phase of the input and output signals may be different, but the frequency is unchanged. If the signal passes through a non-linear, non-ideal system, the output will include other harmonic frequencies in addition to the original frequency. Total harmonic distortion (THD) is a tool to describe the proportion of these harmonic components.

The non-linearity of the characteristic parameters of the loudspeaker itself is the main cause of the sound distortion. The performance of a micro speaker is closely related to three physical parameters: the magnetic parameter BL, the stiffness K of the drum paper, and the friction loss Rms.

For an ideal distortion-free system, the above three parameters are all fixed values. In reality, these three parameters will change due to changes in the voice coil position and speed. When the amplitude of the change is larger, the harmonic distortion is higher. The ideal solution is to make the three parameters constant and remain unchanged with the voice coil. However, this is difficult to achieve in practice.

As an improvement method, the three parameters can be close to constant values by minimizing the variation of the three parameters with the change in the position/speed of the voice coil. This application proposes an improved surround element for reducing the sound distortion of loudspeakers.

### SUMMARY OF THE INVENTION

One object of the present disclosure is to provide an improved drum paper with reduced sound distortion so as to solve the problems mentioned in the background art.

To achieve the above objective, the present disclosure provides the following technical solution.

A surround element is provided with an anti-distortion structure. The anti-distortion structure includes at least one convex arc and at least one concave arc arranged in a ring shape.

As a further solution of the present disclosure, the at least one convex arc and the at least one concave arc are connected to each other.

As a further solution of the present disclosure, the at least one convex arc and the at least one concave arc have different arc radii.

According to another aspect of the present disclosure, a distortion-reducing drum paper including a diaphragm is provided. The surround element is provided around the diaphragm.

According to another aspect of the present disclosure, a speaker is provided, and the speaker includes the distortion-reducing drum paper described above.

Compared with the prior art, the present disclosure the following benefits. By combining the design of the shape of the surround element with the concave arc and convex arc, the stiffness K of the drum paper can be greatly reduced with the change of the position of the voice coil, thereby reducing sound distortion of the loudspeakers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic structural diagram of an improved drum paper with reduced sound distortion.

FIG. 2 is a cross-sectional view taken along the line A-A in FIG. 1.

FIG. 3 is a perspective view of an improved drum paper with reduced sound distortion.

FIG. 4 is a schematic structural diagram of a conventional drum paper.

FIG. 5 shows the change of the stiffness K of the conventional drum paper in relation to the position of the voice coil.

FIG. 6 shows the change of the stiffness K of the improved drum paper with reduced sound distortion in relation to position of the voice coil.

FIG. 7 is a comparison diagram of harmonic distortion of the prior art drum paper and the improved drum paper with reduced sound distortion.

FIG. 8 illustrates an exemplary cross section of a loudspeaker including the improved drum paper with reduced sound distortion.

FIG. 9 is a cross section view showing a portion of the drum paper including the surround element in accordance with one embodiment of the invention.

FIG. 10 is a simplified diagram showing the two connected arcs of the surround element of FIG. 9.

FIG. 11 is a schematic, cross-sectional diagram showing an exemplary surround element in accordance with another embodiment of the invention.

### DETAILED DESCRIPTION

In the following, the technical solutions in the embodiments of the present disclosure will be clearly and completely described with reference to the drawings in the embodiments. Obviously, the described embodiments are only a part of the embodiments of the present disclosure, rather than all the embodiments. Based on the exemplary embodiments of the present disclosure, all other embodiments obtained by a person of ordinary skill in the art without making creative work belong to the scope of the present disclosure.

### Embodiment 1

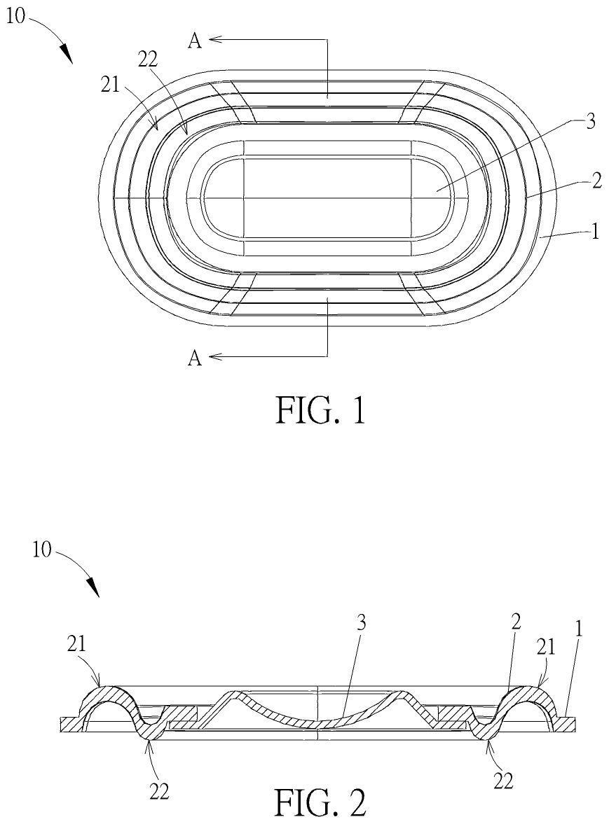

Please refer to FIG. 1 to FIG. 3. In Embodiment 1 of the present disclosure, an improved drum paper 10 with reduced sound distortion includes a diaphragm 3. The diaphragm 3 is provided with a monolithic surround element 1 around the perimeter of the diaphragm 3. The surround element 1 is provided with an anti-distortion structure 2. The anti-distortion structure 2 includes at least one convex arc 21 and at least one concave arc 22 arranged in a ring shape or annular shape. As can be best seen in FIG. 2, the convex arc 21 is disposed to form the outer ring and the concave arc 22 is disposed to form the inner ring around the diaphragm 3. The corrugated structure of the anti-distortion structure 2 in the radial direction from the center of the dram paper 10 to the outer rim of the surround element 1 helps to reduce the sound distortion.

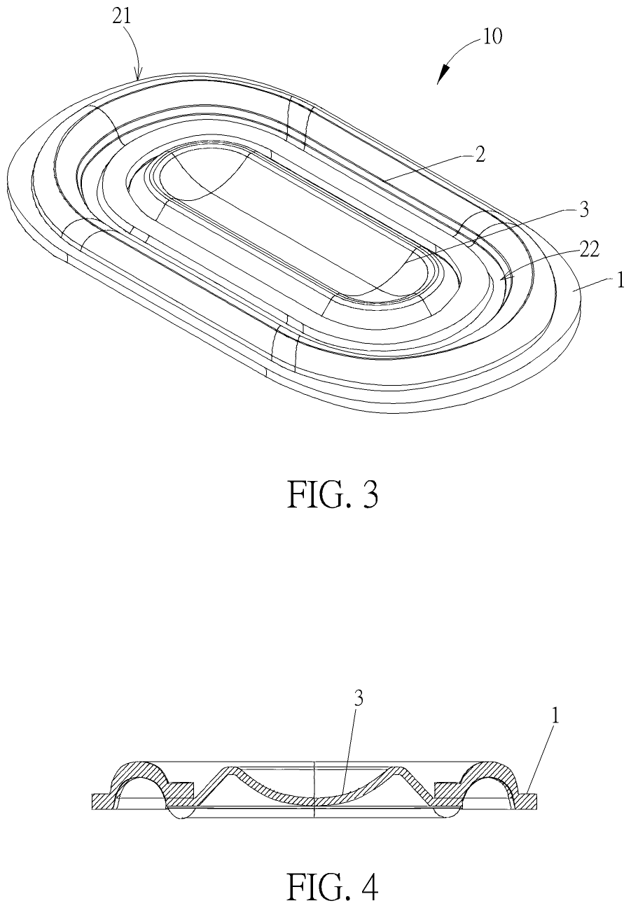

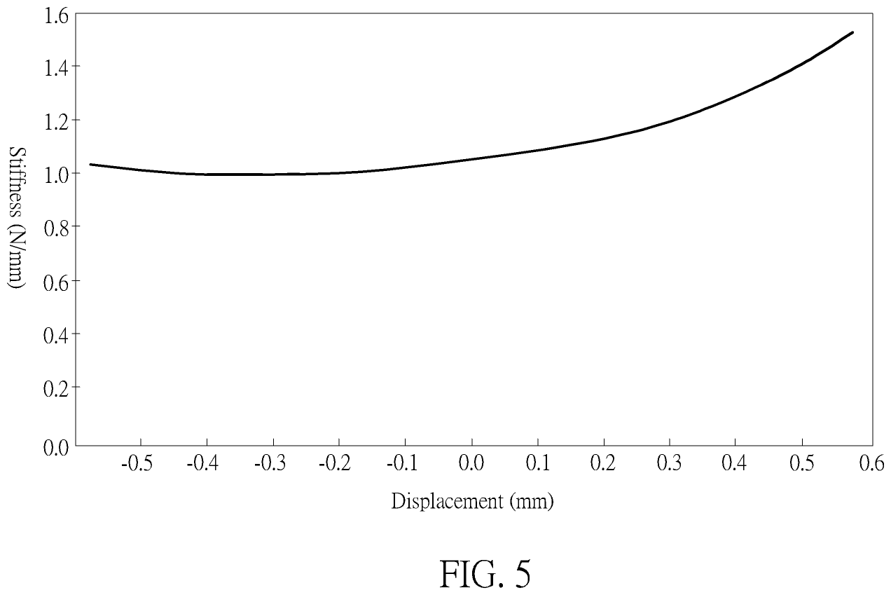

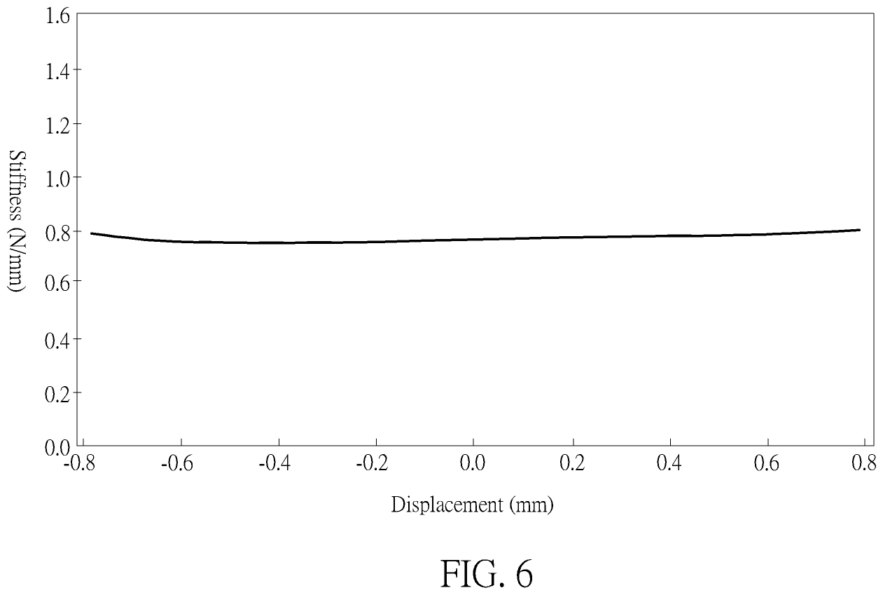

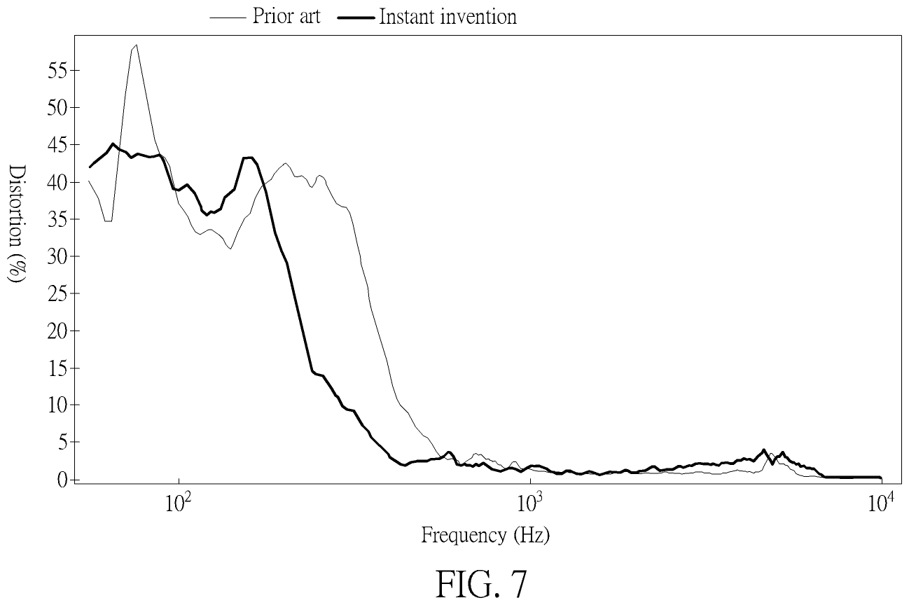

In the prior art, as shown in FIG. 4, only convex-arc or single-half arc settings are usually designed, which often leads to sound distortion of the loudspeaker. By combining the shape design of the surround element with concave arcs and convex arcs arranged in the radial direction from the center of the dram paper 10 to the outer rim of the surround element 1, the stiffness K of the drum paper 10 can be greatly reduced with the change of the position of the voice coil, thereby achieving the effect of reducing sound distortion, as shown through FIG. 5 to FIG. 7. In FIG. 6, the stiffness K may substantially remain constant with the change of displacement. FIG. 7 shows that the sound distortion is significantly improved, especially between 300 Hz-400 Hz.

According to one embodiment, preferably, the convex arc 21 and the concave arc 22 described in this embodiment are connected.

According to one embodiment, the convex arc and the concave arc have different arc radii.

### Embodiment 2

FIG. 8 illustrates an exemplary cross section of a loudspeaker 100 including the above-mentioned drum paper 10 with reduced sound distortion. As shown in FIG. 8, the exemplary loudspeaker 100 may generally comprise a frame 4, a magnetic element 5 mounted inside the frame 4, and a voice coil 6 movably coupled with the magnetic element 5. The diaphragm 3 may be secured to one upper end of the voice coil 6 and may be driven by the voice coil 6, such that the loudspeaker 100 converts an electrical audio input signal into an emitted sound. The surround element 1 connects the diaphragm 3 with the frame 4. The surround element 1 is provided with the anti-distortion structure 2 as described above. The anti-distortion structure 2 includes at least one convex arc 21 and at least one concave arc 22 arranged in a ring shape or annular shape around the diaphragm 3 that is situated in a central region of the loudspeaker 100. The corrugated structure of the anti-distortion structure 2 in the radial direction from the center of the dram paper 10 to the outer rim of the surround element 1 helps reduce the sound distortion.

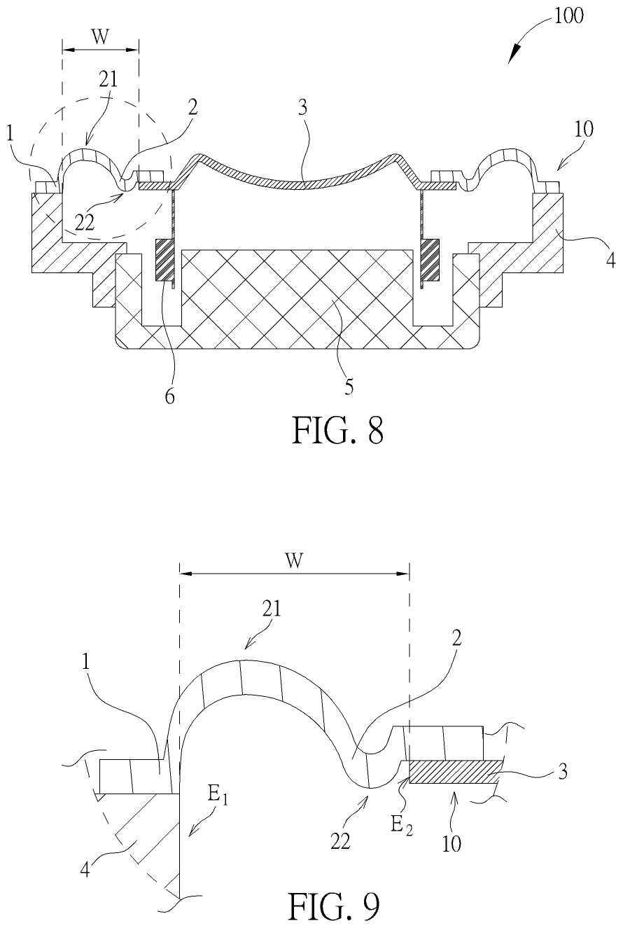

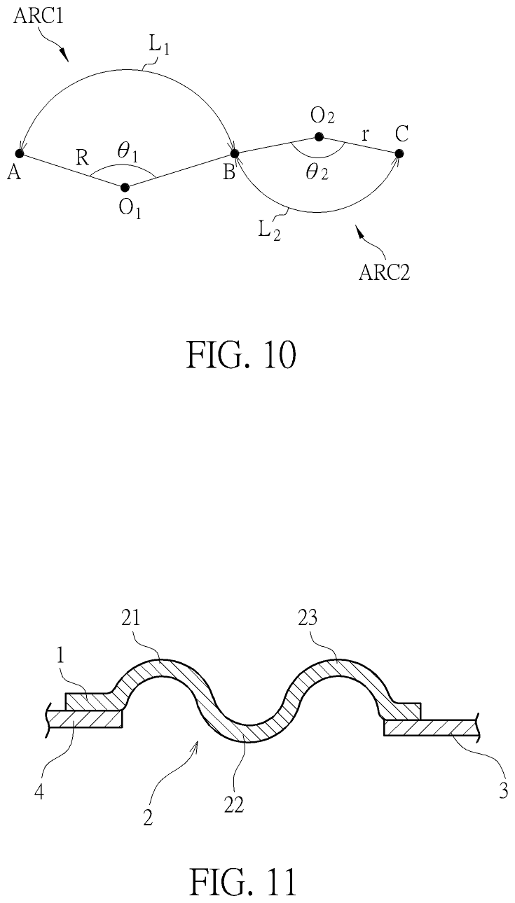

Please refer to FIG. 9 and FIG. 10. FIG. 9 is an enlarged cross-sectional view showing a portion of the drum paper 10 including the surround element 1 in accordance with one embodiment of the invention. FIG. 10 is a simplified diagram showing the two connected arcs of the surround element 1 of FIG. 9. As shown in FIG. 9, likewise, the drum paper 10 comprises the surround element 1 having its one distal end mounted on a surface of the frame 4 and the other end connected to the diaphragm 3. The frame 4 has an inner edge E₁ and the diaphragm 3 has an outer edge E₂. According to one embodiment, the surround element 1 has a L/W ratio ranging between 1.2 and 3.5, wherein W is the distance between the inner edge E₁ and the outer edge E₂, and L is the total arc length of the anti-distortion structure 2 between the inner edge E₁ and the outer edge E₂. Conventionally, the prior art drum paper has L/W ratio of about 1.15. The present invention can provide greater L/W ratio and the increase in L makes the strain or stress distribution become more uniform when the drum paper 10 vibrates.

As shown in FIG. 10, the simplified diagram shows that the anti-distortion structure 2 between the inner edge E₁ and the outer edge E₂ in FIG. 9 is basically composed of two connected arcs: ARC1 and ARC2. According to one embodiment, ARC1 between the point A and point B may have an arc radius R that is greater than an arc radius r of ARC2 between the point B and point C. The arc length L₁ of ARC1 may be represented by L₁=θ₁×R and the arc length L₂ of ARC2 may be represented by L₂=θ₂×r, wherein θ₁ and θ₂ are subtended angles (in radians) of ARC1 and ARC2, respectively. The total arc length L is the combination of L₁ and L₂ (L=L₁+L₂).

### Embodiment 3

FIG. 11 is a schematic, cross-sectional diagram showing an exemplary surround element in accordance with another embodiment of the invention. It is to be understood that the surround element may have multiple convex arcs and multiple concave arcs. As shown in FIG. 3, the exemplary surround element 1 comprises two convex arcs 21 and 23 with one concave arc 22 interposed between the two convex arcs 21 and 23. The two convex arcs 21 and 23 and the concave arc 22 may have different arc radii.

The working principle of the disclosure is: by combining the shape design of the surround element with concave arc and convex arc arranged in the radial direction from the center of the dram paper to the outer rim of the surround element, the stiffness K of the drum paper can be greatly reduced with the change of the position of the voice coil, thereby achieving the effect of reducing sound distortion, as shown through FIG. 5 to FIG. 7.

The detection of the change in the stiffness K of the drum paper according to the position of the voice coil and the detection of harmonic distortion are based on the method of reducing distortion of an ultra-thin speaker according to the prior art Chinese patent (application number: CN106060730B), and the method is disclosed for detection.

In the description of the present disclosure, it should be understood that the terms “center”, “vertical”, “horizontal”, “top”, “bottom”, “inner”, “outer”, “upper”, “lower”, The directions or position relationships indicated by “front”, “rear”, “left”, “right”, “vertical”, “horizontal”, etc. are based on the directions or position relationships shown in the drawings, and are only for the convenience of describing this utility The novel and simplified description, rather than indicating or implying that the device or element referred to, must have a specific orientation, be constructed and operate in a specific orientation, and therefore cannot be understood as a limitation on the present disclosure.

It is obvious to a person skilled in the art that the present disclosure is not limited to the details of the above exemplary embodiments, and that the present disclosure can be implemented in other specific forms without departing from the spirit or basic characteristics of the present disclosure. Therefore, the embodiments are to be regarded as exemplary and non-limiting in every respect. The scope of the present disclosure is defined by the appended claims rather than the above description, and is therefore intended to fall within the scope of the rights. All changes within the meaning and scope of the required equivalent requirements are encompassed within the present disclosure. Any reference signs in the claims should not be construed as limiting the claims involved.

In addition, it should be understood that although this specification is described in terms of embodiments, not every embodiment includes only an independent technical solution. This description of the specification is for clarity only, and those skilled in the art should take the specification as a whole. The technical solutions in the embodiments can also be appropriately combined to form other implementations that can be understood by those skilled in the art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A surround element, comprising:
an anti-distortion structure comprising at least one convex arc and at least one concave arc, wherein the convex arc and the concave arc are both arranged in a ring shape and are disposed in a radial direction.

2. The surround element according to claim 1, wherein the at least one convex arc and the at least one concave arc are connected to each other in the radial direction.

3. The surround element according to claim 2, wherein the at least one convex arc and the at least one concave arc have different arc radii.

4. A drum paper with reduced sound distortion, comprising a diaphragm, wherein the diaphragm is coupled with the surround element according to claim 1.

5. A loudspeaker, comprising the drum paper with reduced sound distortion according to claim 4.

6. A loudspeaker, comprising:
a drum paper comprising a diaphragm coupled with a surround element, the surround element comprising an anti-distortion structure with at least one convex arc and at least one concave arc, wherein the at least one convex arc and the at least one concave arc are both arranged in a ring shape and are disposed in a radial direction; and
a frame, wherein the surround element is secured to the frame;
wherein the surround element has a L/W ratio ranging between 1.2 and 3.5, wherein W is distance between an inner edge of the frame and an outer edge of the diaphragm, and L is total arc length of the anti-distortion structure between the inner edge and the outer edge.
